(19) United States
(12) Patent Application Publication
(10) Pub. No.: US 2014/0313018 A1
(43) Pub. Date: Oct. 23, 2014

(54) STAGE EQUIPMENT SYSTEM

(71) Applicants: Henrik Douglas Green, Viby J (DK); Mikkel Bandholm, Aarhus C (DK); Peter Johansen, Ry (DK)

(72) Inventors: Henrik Douglas Green, Viby J (DK); Mikkel Bandholm, Aarhus C (DK); Peter Johansen, Ry (DK)

(73) Assignee: SGM HOLDING APS, 8230 ABYHOJ (DK)

(21) Appl. No.: 14/241,160

(22) PCT Filed: Sep. 6, 2012
(86) PCT No.: PCT/IB2012/001714

§ 371 Date: Jun. 12, 2014

(30) Foreign Application Priority Data
Sep. 9, 2011 (IT) MI2011A001631

(51) Int. Cl. G05B 19/05

(52) U.S. Cl. CPC G05B 19/05
USPC 340/12.51

(57) ABSTRACT

A stage equipment system including a stage equipment device provided with a signal processor and a memory, including a user interface associated to said stage equipment device; and including a mobile device. The mobile device includes a communication module configured for connecting, by a wireless communication, said user interface to said stage equipment device.

### BACKGROUND

1. Technical Field

The present disclosure relates to a stage equipment system.

In particular, the disclosure relates to a stage equipment system comprising lighting and audio equipment and the following specification is drafted with reference to this field of application.

2. Description of the Related Art

As is well known, common for lighting and audio equipment is that they often are used by rental companies.

The various stage equipment are often packed in Flight cases for transport from a warehouse to a given event and back.

There is often little time to maintain the equipment between each event, hence there is little time in the warehouse.

To be able to maintain and control that every electrically equipment are ready for the next event, the technician needs to take the equipment out of the flight case, plug it in, power it up and test the device.

This operation is time consuming and in most case not satisfactory for the little time available.

The technical problem of the present disclosure is, therefore, to provide a stage equipment system improved in terms of easiness of maintaining and controlling to overcome the drawbacks of the cited prior art.

### BRIEF SUMMARY

The technical problem is solved by a stage equipment system comprising a stage equipment device provided with a signal processor configured for checking at least stage equipment device working parameters representative of working conditions of said stage equipment device, and provided with a memory configured for storing at least values of working parameters indicating an unhealthy condition of said stage equipment device, wherein the stage equipment system further comprises a user interface associated to said stage equipment device and configured for showing values of said working parameters, and wherein the stage equipment system further comprises a mobile device comprising a communication module configured for connecting, by a wireless connection, said user interface to said stage equipment device.

The disclosure will be explained more in detail in the description provided below and with the help of indicative and not limiting embodiments related to the annexed drawings.

### BRIEF DESCRIPTION OF THE SEVERAL VIEWS OF THE DRAWINGS

FIG. 1a shows a blocks diagram of a first embodiment of the system according to the disclosure.

FIG. 1b shows a blocks diagram of a second embodiment of the system according to the disclosure.

### DETAILED DESCRIPTION

The stage equipment system of the disclosure comprises a stage equipment device provided with a signal processor and a memory, a user interface associated to said stage equipment device, and a mobile device comprising a communication module configured for connecting, by a wireless communication, the user interface to the stage equipment device.

According to Figures, the stage equipment system comprises a stage equipment device 20.

It has to be understood that a plurality of stage equipment devices 20 can be comprised in the stage equipment system of the disclosure.

In one embodiment, such stage equipment device 20 comprises lighting equipment.

In one embodiment the lighting equipment comprises one or more among:

moving heads;

colour changers;

video screens;

LED lighting fixtures
or the like.

In one embodiment, such stage equipment device 20 comprises audio equipment.

In one embodiment the audio equipment comprises one or more among:

amplifier;

speakers;
or the like.

Every stage equipment device 20 comprises a signal processor 21. The signal processor 21 is a DSP (Digital Signal Processor) usually used to measure, filter and/or compress continuous real-world analog signals by converting the signal from an analog to a digital form, using an analog-to-digital converter (ADC) and, eventually, by converting the stream obtained in another output signal, by using a digital-to-analog converter (DAC).

The signal processor 21 manages light and/or sound signals in the stage equipment device 20.

The signal processor 21 of the disclosure is configured for checking at least stage equipment device working parameters Pi. The working parameters Pi are representative of working conditions of the stage equipment device 20.

In other words, the signal processor 21 processes the received light or audio signals to obtain values of the working parameters Pi needed to check the health of the device.

As an example, working parameters Pi are various error logs, temperature measurement or various set points, like communication address, operation modes, etc.

The signal processor 21 is further configured for checking at least stage equipment device configuration parameters Ci.

The configuration parameters Ci are representative of settings of the stage equipment device 20.

Specifically, the configuration parameters Ci comprise one or more among stage equipment device 20 identification features:

Device identification;

address;

timing of working;

tilting and/or azimuth angle;

pointing direction of the light;

light colour;

etc;
or the like.

It has to be understood that any other configuration parameter can be considered depending on the programmable features provided in the stage equipment device 20.

Every stage equipment device 20 comprises a memory 22.

The memory 22 is configured for storing at least values Vi of the working parameters Pi indicating unhealthy working conditions of the stage equipment device 20.

The memory 22 is further configured for storing at least values Vj of the configuration parameters Ci indicating setting conditions of the stage equipment device 20.

The stage equipment system comprises a user interface 40 associated to the stage equipment device 20.

The user interface 40 is configured for showing the values Vi of the checked parameters Pi and/or for showing the values Vj of the configuration parameters Ci.

It has to be understood that other parameters can be shown by the user interface 40 depending on services and functions provided by the stage equipment system.

According to the disclosure, stage equipment system comprises a mobile device 10.

The mobile device 10 further comprises a communication module 11 configured for connecting the user interface 40 to a said stage equipment device 20.

According to the disclosure, the communication module 11 connection is carried out as a wireless connection.

The technical effect achieved is that no physical connection is needed to the device for the communication therewith.

In one embodiment, the mobile device 10 is a PDA (Personal Digital Assistant), specifically one or more among:

a mobile phone;

tablet PC;

portable hard drive;
Or the like.

The stage equipment system comprises a control unit 30 interposed between the user interface 40 and the stage equipment device 20.

According to the disclosure, the stage equipment system comprises a database 50.

The database 50 is connected to the control unit 30 and configured for storing one or more between the working parameters Pi and the configuration parameters Ci.

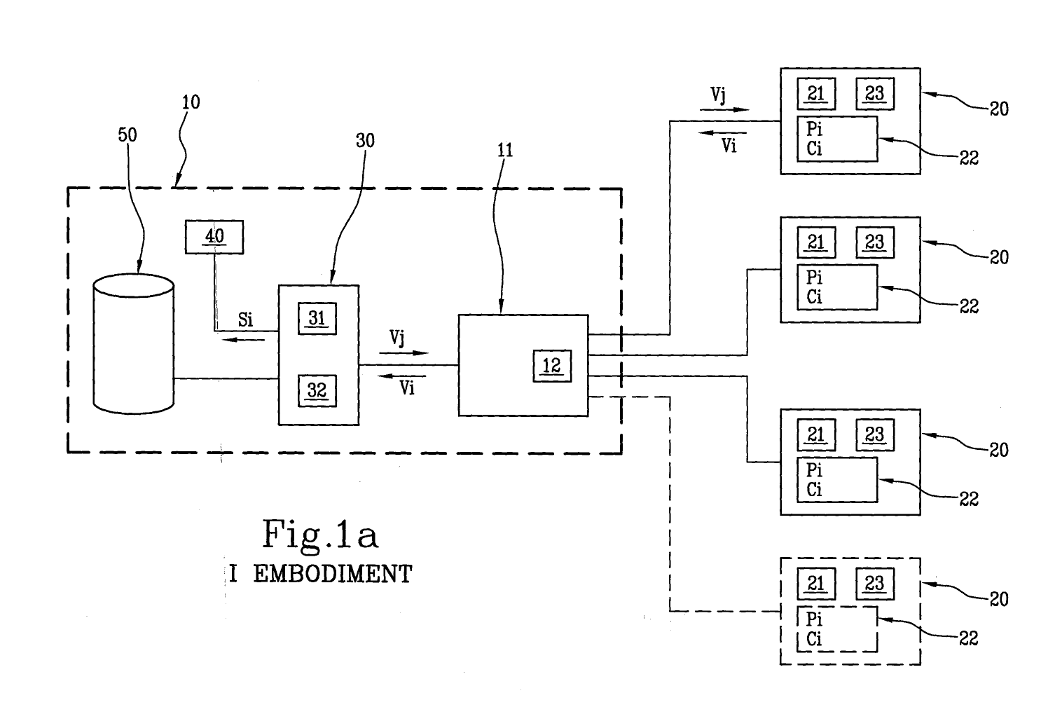

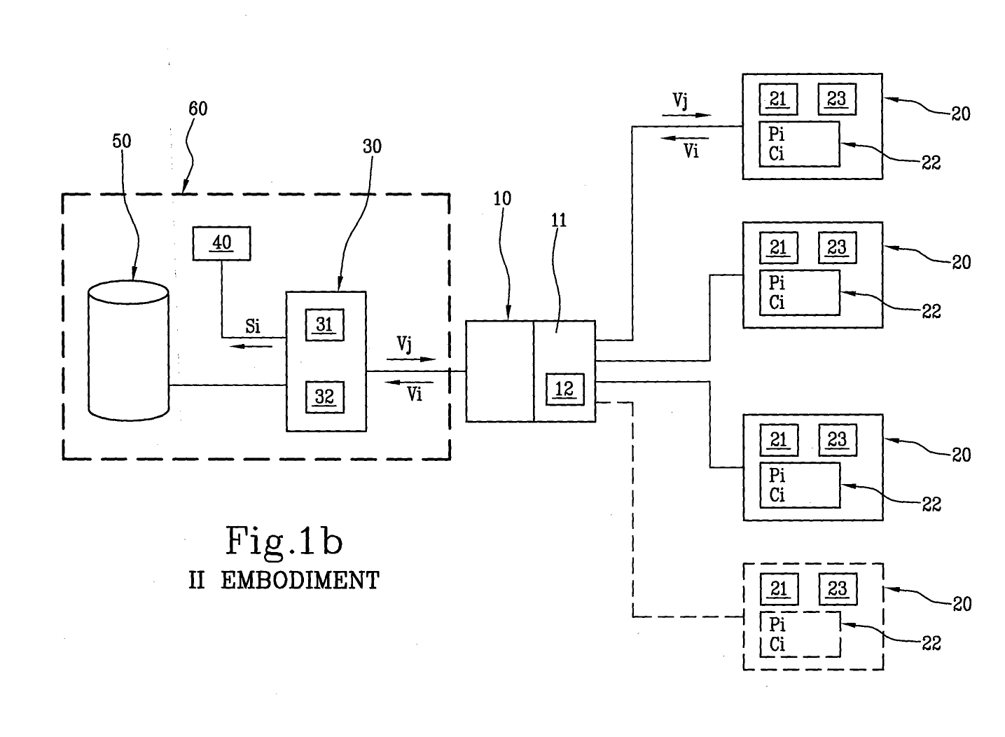

According to a first embodiment of the disclosure (FIG. 1a), the mobile device 10 comprises the control unit 30.

In one embodiment, the mobile device 10 further comprises the database 50.

As an alternative, according to a second embodiment of the disclosure (FIG. 1b), a further auxiliary device 60, distinct and connected to the mobile device 10, is provided in the stage equipment system.

The auxiliary device 60 comprises the control unit 30.

In one embodiment, the auxiliary device 60 further comprises the database 50.

In both embodiments, the stage equipment system allows two-way communication between the stage equipment device 20 and the mobile device 10 provided or not with the control unit 30.

In the description the mobile device 10, provided with the control unit 30, and the auxiliary device 60 will be referred to as apparatuses connectable to the device 20.

The connection between the connectable apparatuses and the stage equipment device 20 is carried out, as already explained by means of the connecting module 11.

According to the disclosure, the connectable apparatus is not only able to read information stored in the stage equipment device 20 (e.g. diagnostics), but can also be used to configure the stage equipment.

For the stage equipment device 20 reading, the control unit 30 comprises a management module 32.

The management module 32 is configured for converting the values Vi into service instructions Si for the user interface 40.

In other words, the management module 32 converts the values Vi in a way friendly to be shown to the user, in particular by coloured LEDs, dedicated icons, or the like.

For the stage equipment device 20 configuration, the control unit 30 comprises a configuration module 31 configured for setting the stage equipment device 20, as a function of the configuration parameters Ci.

According to the disclosure, configuring the stage equipment device 20 means first of all giving the stage equipment 20 an identification and an address.

In the case, for example, of the case of lighting devices, the connectable apparatus which controls the stage arrangement has a number of information about how each lighting device must behave.

For example, lighting device no. x must be switched on at a certain moment, with LEDs of a certain colour and must be positioned according to a certain angle.

In one embodiment, these information are comprised in the database 50 connected to the control unit 30.

Each time a stage is prepared, each lighting device must be configured by giving it an address (for example “you are lighting fixture no. 4”), so that the connectable apparatus can control that particular lighting device according to the instructions stored in the connectable apparatus, in particular in the database 50.

Differently to the configuration carried out in the prior art systems, wherein operations are normally done manually, by means of some buttons or a small keyboard provided on the lighting device and the operator has to open the case in which the lighting device is packed, to take the lighting device out of the case, to connect the lighting device to a power supply, switch it on and then configure it manually, the system according to the disclosure allows the performing totally automatically of configuration operations, by simply putting the mobile device 10, close to the lighting device, which can still be packed in the case and disconnected from the power supply. According to the disclosure, for the communication between the stage equipment device and the mobile device 10, the communication module 11 in the mobile device 10 uses a RFID technology namely, as known, a technology that uses communication through the use of radio waves to exchange data between a reader and an electronic tag attached to an object, for the purpose of identification and tracking.

RFID makes it possible to give each device in a grocery store its own unique identifying number, to provide all with individual unique identifiers.

This is a vast improvement over paper and pencil tracking or bar code tracking that has been used since the 1970s. Differently from the barcode technology, RFID technology does not require a line of sight to “see” an RFID tag; the tag can be read inside a case, carton, box or other container, and unlike barcodes, RFID tags can be read hundreds at a time.

According to the disclosure, the communication module 11 comprises an RFID reader 12.

On the other hand, the stage equipment device 20 comprises an RFID tag 23.

The RFID-tag 23 in a lighting device is then activated and the RFID-reader 12 can configure the tag saving time with respect to the operations of the prior art.

According to the disclosure, specifically, the RFID tag 23 is a passive RFID tag.

In other words, the tag does not need to have a battery therein. The technical effect of this feature is that there is no need to have power in the lighting device or other stage equipment when it communicates with the reader, because the power is transmitted to the RFID 23 tag by the RFID reader 12.

Therefore, the lighting device can be inspected or configured even when it is disconnected from the power supply.

As known, RFID can be of the near field type or long range type, thereby providing wide alternative of use in the warehouse to detect and check the stage equipment devices.

To sum up, as is known, the RFID technology enables an active device, RFID-Reader, to communicate with a passive device, RFID-Tag.

The active device can be a computer attached to a huge antenna in the floor or a smaller handheld device that can be held over the flight case.

When the radio signal from the RFID-Reader reaches the RFID-Tag in the fixture, it awakens the RFID-Tag and the RFID-Tag is ready for communication.

The RFID-Reader can now transmit commands and settings to the RFID-Tag.

Settings could be Addresses, Modes etc.

A Command could be a request for Error Logs, Temperature Logs, etc.

The data retrieved by the RFID-Reader can be transferred to an online database capable of interfacing to a user or interfacing to other databases. Such an online database can be the mobile device 10 provided with the control unit 30 and the database 50. As an alternative the online database can be the auxiliary device 60.

The RFID-Tag is registered by means of a Unique ID, UID, that can be registered in a PC database, as example the database 50 connected to the control unit 30.

In this way the System can keep a log of errors, operating hours etc.

With a PC based database it is easy to get an overview of which fixtures that are in the warehouse and which ones that is on the road.

It will be possible to get a report over each fixture, to see how it performs and if any component needs to be replaced just in time before they break down on the road.

Although reference is made to RFID, other kinds of wireless communication could be used.

Furthermore, not only lighting devices, but also any kind of stage equipment (for example speakers, amplifier, etc.) could be equipped with the RFID tag.

According to the disclosure, as above described the following advantageous effects are achieved:

communication with a stage equipment device not requiring a physical connection.

due to the possibility to retrieve data from a given device while powered off and still placed in the flight case, an efficient warehouse is provided in the rental business.

the maintaining and controlling of a given device is easy and fast.

1. Stage equipment system comprising:
a stage equipment device provided with:
a signal processor configured for checking at least stage equipment device working parameters representative of working conditions of said stage equipment device;
a memory configured for storing at least values of working parameters indicating said an unhealthy condition of said stage equipment device;
a user interface associated to said stage equipment device and configured for showing values of said working parameters;
a mobile device comprising a communication module configured for connecting, by a wireless connection, said user interface to said stage equipment device.

2. Stage equipment system according to claim 1, wherein:
said signal processor is further configured for checking at least stage equipment device configuration parameters representative of a setting of said stage equipment device; and
said memory is configured for storing at least values of configuration parameters indicating setting conditions of said stage equipment device;
said user interface is configured for showing said values of said configuration parameters.

3. Stage equipment system according to claim 2, further comprising a control unit interposed between said user interface and said stage equipment device.

4. Stage equipment system according to claim 3, further comprising a database connected to said control unit and configured for storing one or more between said working parameters and said configuration parameters.

5. Stage equipment system according to claim 4, wherein said control unit comprises a configuration module configured for setting said stage equipment device, as a function of said configuration parameters.

6. Stage equipment system according to claim 4, wherein said mobile device further comprises said control unit and said database.

7. Stage equipment system according to claim 4, further comprising an auxiliary device distinct and connected to said mobile device, said auxiliary device comprising said control unit and said database.

8. Stage equipment system according to claim 1, wherein said communication module comprises an RFID reader and said stage equipment device comprises an RFID tag.

9. Stage equipment system according to claim 8, wherein said RFID tag is a passive RFID tag.

10. Stage equipment system according to claim 1, wherein said mobile device is a Personal Digital Assistant selected from:
a mobile phone;
tablet PC;
portable hard drive.

11. Stage equipment system according to claim 1, wherein said stage equipment device comprises, in lighting equipment, one or more among:
Moving Heads;
Colour Changers;
Video Screens;
LED Lighting fixtures.

12. Stage equipment system according to claim 2, wherein said configuration parameters comprise one or more stage equipment device identification features among:
Device identificator;
address;
timing of working;
tilting and/or azimuth angle;
pointing direction of the light;
light colour.

13. Stage equipment system according to claim 1, wherein said working parameters comprise one or more among:
error logs;
temperature measurement;
various set points, like communication address, operation modes.
